(19) United States
(12) Patent Application Publication
(10) Pub. No.: US 2017/0254050 A1
(43) Pub. Date: Sep. 7, 2017

(54) SYSTEM AND METHOD FOR OPERATING IMPLEMENT SYSTEM OF MACHINE

(71) Applicant: Caterpillar Inc., Peoria, IL (US)

(72) Inventor: Christopher R. Wright, Peoria, IL (US)

(73) Assignee: Caterpillar Inc., Peoria, IL (US)

(21) Appl. No.: 15/059,655

(22) Filed: Mar. 3, 2016

(51) Int. Cl. E02F 9/26; E02F 3/43; B60R 16/027

(52) U.S. Cl. CPC E02F 9/262; B60R 16/027; E02F 9/264; E02F 3/435; E02F 3/32

(57) ABSTRACT

A system for operating machine is provided. The system includes input unit having plurality of cameras associated with the machine and worksite. The input unit is adapted to generate visual feed associated with machine and worksite. The system further includes controller, in communication with the input unit, to receive the visual feed generated by the plurality of cameras. The system further includes an interactive display unit, in communication with the controller. The controller is adapted to display visual feed generated by the plurality of cameras on interactive display unit. The interactive display unit displays first feature interface on the interactive display unit to allow first input from operator for movement of implement system of the machine along first plane and displays second feature interface on the interactive display unit to allow second input from the operator for movement of the implement system of the machine along second plane.

### TECHNICAL FIELD

The present disclosure relates generally to a control device for an implement system of a machine, and in particular, to a control device for remotely controlling the implement system of an excavator.

### BACKGROUND

An implement system of a typical excavator machine includes a linkage structure operated by hydraulic actuators to move a work implement. The implement system includes a boom that is pivotal relative to a machine chassis, a stick that is pivotal relative to the boom, and a work implement that is pivotal relative to the stick. The machine chassis is rotatably mounted on an undercarriage or a drive system of the excavator, and is adapted to swing about a vertical axis.

Further, the machine chassis carries a cabin which has various machine controls provided therein. Typically, a machine operator occupies the cabin, and controls the movement of the implement system using the machine controls. Since, the machine may be required to operate in various conditions, for example, a work site with dust or fumes, or a work site where there is a risk of machine rolling over, the machine operator sitting within the cabin is not far from such operational risks. Alternatively, the machine may be operated by an operator situated remotely from the machine, wherein the operator relies on cameras and/or other locating instruments to provide a visual indication of the machine and surrounding worksite.

For reference U.S. Pat. No. 9,110,468 B2 discloses a remote operator station for controlling an operation of a machine. The remote operator station comprises a display device, a plurality of control devices, and a controller communicably coupled to the display device and the control devices. The controller is configured to display a list of types of machines capable of being operated remotely. The controller receives an input indicative of a machine selected from the list. The controller determines a plurality of functionalities associated with the operation of the selected machine. The controller maps the determined functionalities to the plurality of control devices and further displays the mapped functionalities associated with the control devices.

### SUMMARY OF THE DISCLOSURE

The present disclosure provides for a system for operating a machine. The system comprises an input unit having a plurality of cameras associated with the machine and a work site. The input unit is adapted to generate a visual feed associated with the machine and the work site. The system further comprises a controller, in communication with the input unit, to receive the visual feed generated by the plurality of cameras. The system further comprises an interactive display unit, in communication with the controller. The controller is adapted to, display the visual feed generated by one or more of the plurality of cameras on the interactive display unit. The interactive display unit displays a first feature interface on the interactive display unit to allow a first input from an operator for movement of an implement system of the machine along a first plane. The interactive display unit further displays a second feature interface on the interactive display unit to allow a second input from the operator for movement of the implement system of the machine along a second plane.

The present disclosure also provides for a computer-implemented method of operating a machine. The method comprises displaying, on an interactive display unit, a visual feed from one or more of a plurality of cameras. The method further comprises receiving an input on a first feature interface of the interactive display unit. The input defining a desired range of movement of an implement system of the machine along a first plane. The method further comprises moving the implement system of the machine along the first plane according to the input received on the first feature interface.

Other features and aspects of this disclosure will be apparent from the following description and the accompanying drawings.

### BRIEF DESCRIPTION OF THE DRAWINGS

FIG. 1 is a schematic diagram of a machine located at a worksite, according to an embodiment of the present disclosure;

FIG. 2 is a block diagram a system included in the machine of FIG. 1 according to an embodiment of the present disclosure;

FIG. 3 is a front view of an interactive display unit included in the system of FIG. 2, according to an embodiment of the present disclosure;

FIG. 4 is a front view of an interactive display unit included in the system of FIG. 2, according to an embodiment of the present disclosure;

FIG. 5 is magnified view of a first feature interface T1 of the interactive display unit of the FIG. 3, according to an embodiment of the present disclosure;

FIGS. 6A and 6B are magnified views of a second feature interface T2 of the interactive display unit of the FIG. 3 and FIG. 4, according to an embodiment of the present disclosure;

FIG. 7 is a flowchart of a computer-implemented method of operating the first feature interface of the machine, according to an embodiment of the present disclosure; and

FIG. 8 is a flowchart of a computer-implemented method of operating the second feature interface of the machine, according to an embodiment of the present disclosure.

### DETAILED DESCRIPTION

Reference will now be made in detail to specific aspects or features, examples of which are illustrated in the accompanying drawings. Wherever possible, corresponding or similar reference numbers will be used throughout the drawings to refer to the same or corresponding parts.

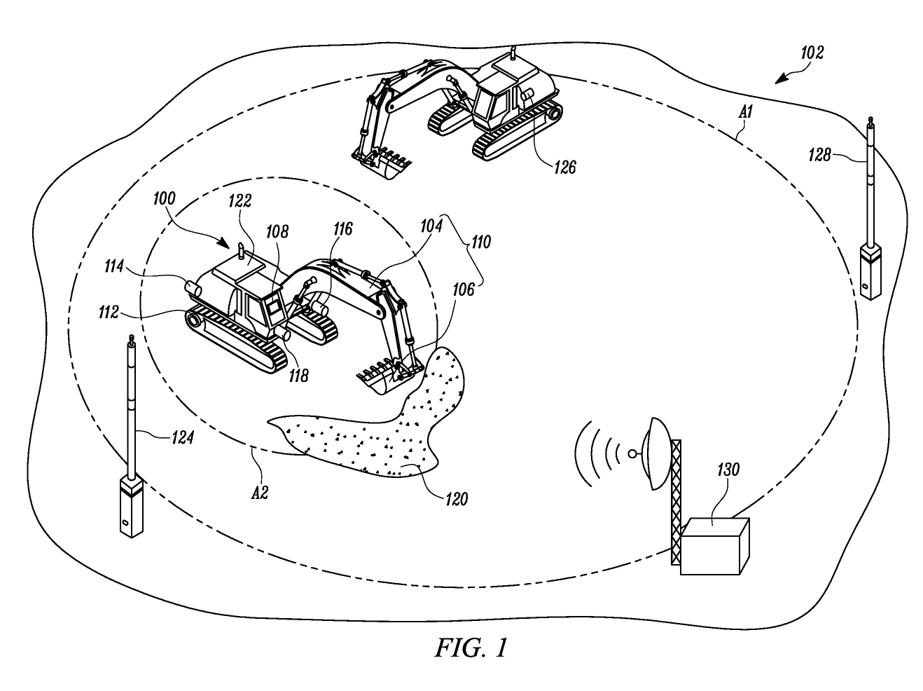

FIG. 1 illustrates an exemplary machine 100, according to one embodiment of the present disclosure. It should be noted that the machine 100 is an excavator machine that may include other industrial machines such as a backhoe loader, shovel, or any other construction machines that are known in the art, and more specifically machines that make use of linkage members. As shown in the FIG. 1, the machine 100 may include a body 122 that is rotatably mounted on tracks 112.

The machine 100 may include a linkage member such as a boom 104 which is pivotally mounted on the body 122. The boom 104 may extend outwards from the body 122. A hydraulic cylinder (or a pair of cylinders), controlled by an operator sitting in an operator cab or by a machine control system, may move the boom 104 relative to the body 122 during operation. The boom 104 and a work tool 106 form an implement system 110 of the machine 100.

Also, a stick may be pivotally mounted at a pivot point to an outer end of the boom 104. Similarly, a hydraulic cylinder may be used to move the stick relative to the boom 104 about the pivot point during the operation. Further, the work tool 106 may be pivotally mounted at a pivot point to an outer end of the stick. A hydraulic cylinder may move the work tool 106 relative to the stick about the pivot during the operation.

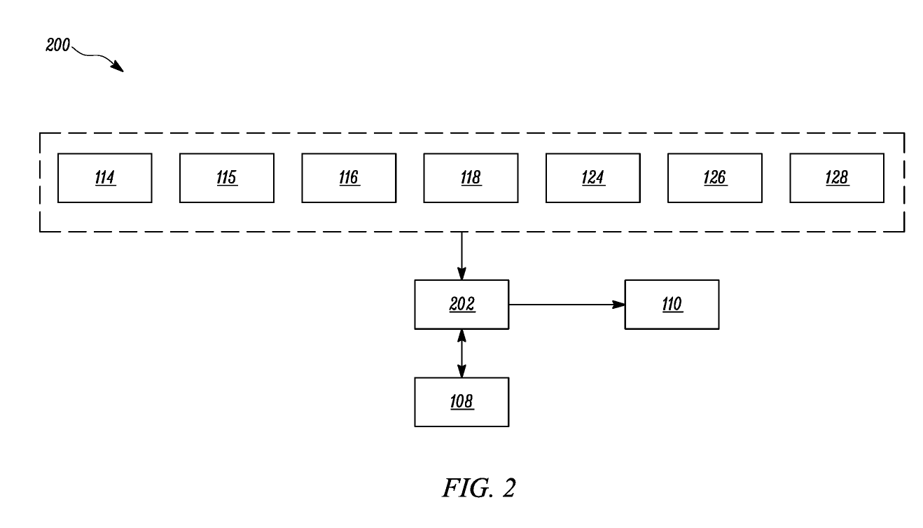

The machine 100 may be located at a worksite 102 during the operation. A plurality of input units is disposed on the machine 100 and the worksite 102 for obtaining images of articles present in front and rear ends of the machine 100 during the operation. In an embodiment, the plurality of input units are, but not limited to, cameras. In an embodiment, cameras 114, 115, 116 and 118 are disposed at front end and rear end of a frame of the machine 100. The cameras 116 and 118 are adapted to capture the images at front end of the machine 100 and the cameras 114 and 115 are adapted to capture images at rear end of the machine 100. In an embodiment, the cameras 114, 115, 116 and 118 may be configured to capture the surrounding of the machine 100. In an embodiment, the cameras 114, 115, 116 and 118 are configured to capture the image in a surrounding area Al. The images captured by the cameras 114, 115, 116 and 118 may include a work aggregate 120 present towards the front end of the machine 100. In an embodiment, the worksite 102 includes a plurality of cameras 124, 126 and 128 disposed at predefined locations or on other machines at the worksite 102. The cameras 124, 126 and 128 capture images of the worksite 102 including that of the machine 100. In an embodiment, the cameras 124, 126 and 128 capture the image of the worksite 102 in a surrounding area A2. The images captured by the cameras 124, 126 and 128 may include articles such as, machines such as, hauling machines, or any other machines that may be used during mining operation. The images captured by the cameras 114, 115, 116, 118, 124, 126 and 128 are communicated to a controller 202 (shown in FIG. 2) of the machine 100.

The controller 202 of the machine 100 is configured to communicate with a remote station 130 for remotely monitoring the machine 100, during the operation of the machine 100. The operator of the machine 100 may communicate with suitable instructions by a supervisor located at the remote station 130, during the operation of the machine 100. The controller 202 is further configured to communicate signals to an interactive display unit 108 to display the images captured by the cameras 114, 115, 116, 118, 124, 126 and 128 for necessary actions during the operation. In an embodiment, the interactive display unit 108 may be configured to be provided at a dashboard (not shown) of the machine 100 or may also be remotely held for monitoring it by the operator operating remotely. The interactive display unit 108 is configured to display image captured by any of the cameras 114, 115, 116, 118, 124, 126 and 128 during operation of the machine 100. The cameras 114, 115, 116, 118, 124, 126 and 128, and the controller 202 may be configured to be in wireless communication with each other. The controller 202 may further be configured to be in wireless communication with the remote station 130. It is contemplated that the communication between the cameras 114, 115, 116, 118, 124, 126 and 128, the controller 202 and the remote station 130 may also be made suitably by wires or any other means which serves the purpose.

FIG. 2 illustrates a block diagram of a system 200 for operating a machine 100, according to an embodiment of the present disclosure. The system 200 includes the plurality of input units, such as the cameras. The cameras may include on-board cameras 114, 115, 116 and 118 provided on the machine 100 and off-board cameras 124, 126 and 128 provided at predefined locations at the worksite 102 or on other machines at the worksite 102. The cameras 114, 115, 116, 118, 124, 126 and 128 are configured to communicate the image captured as a visual feed to the controller 202. The image captured by the cameras 114, 115, 116, 118, 124, 126 and 128 may include image of the worksite 102 and also articles present in front end and rear end of the machine 100. The controller 202 is configured to receive and process the visual feed communicated by the cameras 114, 115, 116, 118, 124, 126 and 128 to generate a single based on the visual feed. The controller 202 is in further communication with the interactive display unit 108. The controller 202 is adapted to display the visual feed generated by the plurality of cameras 114, 115, 116, 118, 124, 126 and 128 on the interactive display unit 108. The interactive display unit 108 is configured to receive input from an operator for operation of the implement system 110, during working of the machine 100.

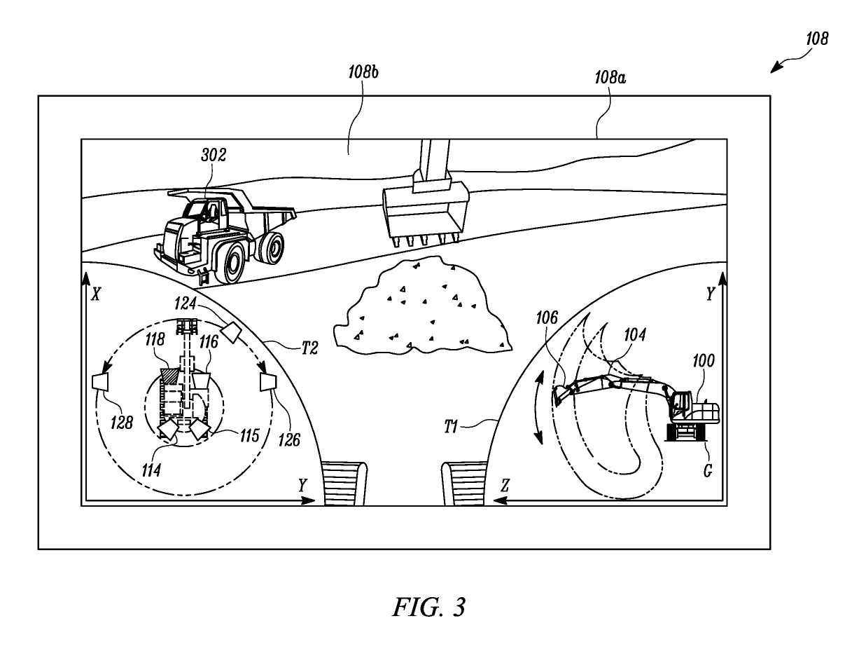

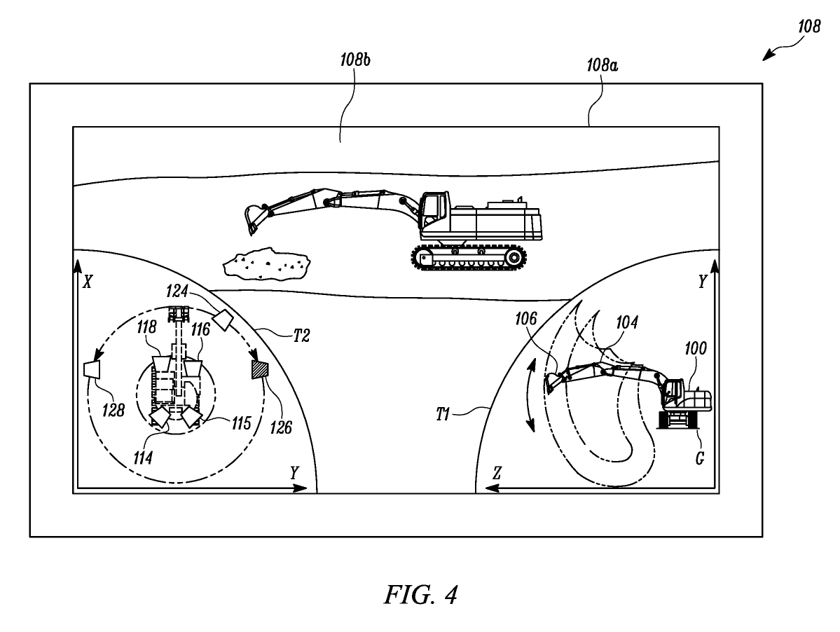

FIG. 3 and FIG. 4 illustrate a front view of the interactive display unit 108, according to an embodiment of the present disclosure. In an embodiment, the interactive display unit 108 is a touch screen panel that may be mounted to the dashboard of the machine 100 or may be operated remotely by an operator. In an exemplary embodiment, the interactive display unit 108 includes a transparent overlay 108a having three partitions in the transparent overlay 108a. It may be understood that the partitions configured in the interactive display may not be construed to limit the scope of the disclosure. The interactive display unit 108 may be configured either with less number of partitions or may also be configured to have more number of partitions than the three partitions.

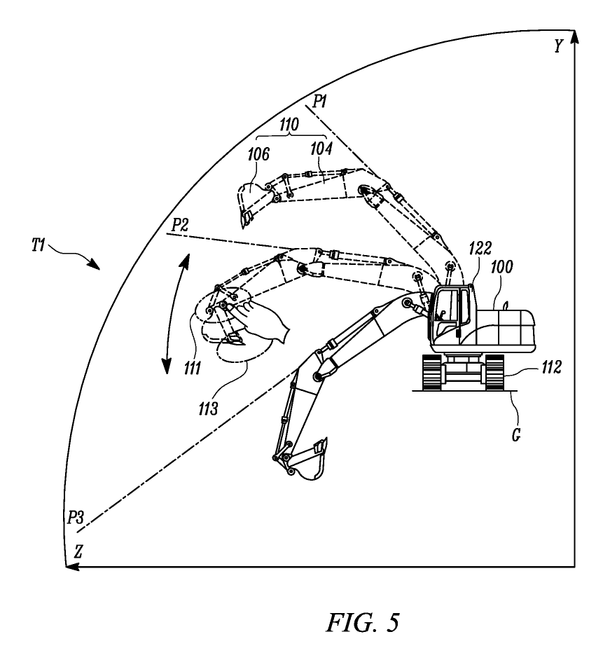

A first feature interface T1 is displayed on the interactive display unit 108. The first feature interface T1 on the interactive display unit 108 allows a first input from the operator for movement of the implement system 110 of the machine 100 along a first plane Y-Z (illustrated in FIG. 5). In an embodiment, the first feature interface T1 is configured at a right bottom corner of the interactive display unit 108. The operator may rotate the implement system 110 including the boom 104 and the work tool 106. The operator by the act of touching and dragging down or up the movement of his finger, rotates or moves the boom 104 of the machine 100 along the first plane Y-Z. In an embodiment, the first feature interface T1 further includes a first Graphical User Interface (GUI) of a range of motion of the implement system 110 along the first plane Y-Z. In an embodiment, the first feature interface T1 includes the first GUI that indicates a range of motion of the work tool 106 along the first plane Y-Z. The work tool 106 may be a bucket. In an embodiment, the first feature interface T1 is adapted to receive the first input for moving the implement system 110 along the first plane Y-Z. For providing the first input for moving the implement system 110 the user may touch at the illustrated touch point 111 and drag the figure up or down as required. Further the first feature interface T1 is adapted to receive a work tool movement input for moving the work tool 106 of the implement system 110 with respect to the implement system 110 along the first plane Y-Z. For providing the work tool movement input for moving the work tool 106 with respect to the implement system 110 the user may touch at the illustrated touch point 113 and rotate the as required.

In an exemplary embodiment, the movement of the boom 104 is configured to also move the work tool 106 relatively during the movement of the boom 104 by the operator. It may be contemplated that the movement of the boom 104 and the work tool 106 may be carried out independently of one another.

Further, a second feature interface T2 is displayed in the interactive display unit 108. The second feature interface T2 in the interactive display unit 108 allows a second input from the operator for movement of the implement system 110 and the body 122 of the machine 100 along a second plane X-Y. In an embodiment, the second feature interface T2 is provided at left bottom corner of the interactive display unit 108. The operator may rotate the implement system 110 which includes the boom 104 and the work tool 106 along the second plane X-Y, by the aid of the second feature interface T2. In an embodiment, the second feature interface T2 includes a second Graphical User Interface (GUI) indicating the implement system 110 range of motion along the second plane X-Y. In an exemplary embodiment, the operator, by the act of touching and rotating the movement of his finger on the implement system 110, rotates the implement system 110 including the boom 104 of the machine 100 along the second plane X-Y.

Further, the second feature interface T2 includes icons representing both the on-board cameras 114, 115, 116 and 118, and the off-board cameras 124, 126 and 128. The icons facilitate the operator to select any of the cameras 114, 115, 116, 118, 124, 126 and 128 for displaying the visual feed from the selected camera. In the illustrated embodiment, the camera 118 is selected by the operator and the image captured by the camera 118 is displayed at a portion 108b in the interactive display unit 108. In another illustrated embodiment, the camera 126 is selected by the operator and the image captured by the camera 126 is displayed at a portion 108b in the interactive display unit 108. The operator may observe articles present in front view of the machine 100 and may take suitable actions accordingly. In an embodiment, the operator may select any other camera to display the image of surrounding areas A1 and A2 and areas at rear view and proximal to the machine 100 at the worksite 102.

In an embodiment, the controller 202 and the interactive display unit 108 are configured to integrally form a part of a mobile computing device. The mobile computing device includes devices such as, but not limited to, a laptop, a Personal Digital Assistant (PDA), a tablet device, and a smartphone.

FIG. 5 illustrates a magnified view of the first feature interface T1 of the interactive display unit 108, according to an embodiment of the present disclosure. The display indicates a rear view of the machine 100. The implement system 110 including the boom 104 and the work tool 106 is configured to be moveable about the first plane Y-Z. The operator may operate the movement of the implement system 110 by touching and dragging the implement system 110 along the first plane Y-Z to a desired angle. In the illustrated embodiment, initially the implement system 110 may be positioned to be in a position P1. The position P1 may be non-working position. When the operator desires to bring the position of the implement system 110 from the position P1 to a working position, the operator touches and drags the implement system 110 along the first plane Y-Z. In the illustrated embodiment, the working position may include position of the implement system 110 at a position P2 and at a position P3. In an embodiment, the first input on the first feature interface T1 includes a draw and dig work cycle of the machine 100.

In an exemplary embodiment, the position of the implement system 110 is moved from the position P1 to the position P2 when the work aggregate 120 is present on a ground surface G. In an exemplary embodiment, the position of the implement system 110 is moved from the position P2 to the position P3 when the machine 100 needs to be operated for deep excavation below the ground surface G at the worksite 102.

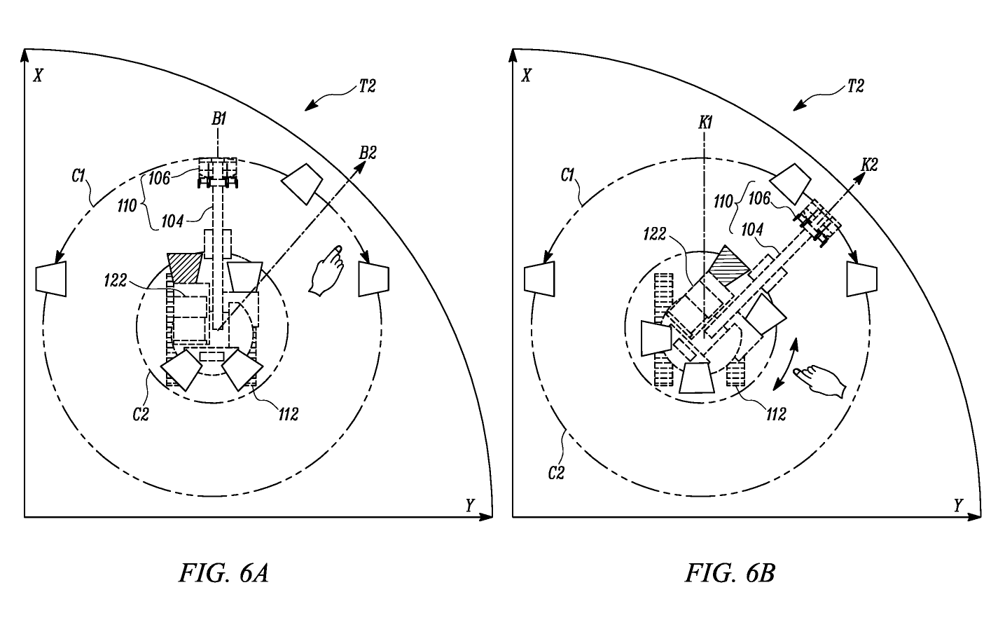

FIGS. 6A and 6B illustrate magnified views of the second feature interface T2 of the interactive display unit 108, according to an embodiment of the present disclosure. The second feature interface T2 is at left bottom corner of the interactive display unit 108 which provides a top view of the machine 100. The implement system 110 including the boom 104 and the work tool 106 and the body 122 is configured to be moveable about the second plane X-Y. The operator operates the movement of the implement system 110 and the body 122 by touching and rotating the implement system 110 along the second plane X-Y to a desired angle. In the illustrated embodiment in the FIG. 6A, the implement system 110 is rotated from a position B1 to a position B2 by touching and rotating a circle C1 at a desired direction. Initially the implement system 110 may be positioned to be in the position B1 and when the operator desires to bring the position of the implement system 110 to another position, for example, the position B2, the operator touches and rotates the circle C1 to a desired angle in a clockwise direction for rotating the implement system 110 along the second plane X-Y. It is contemplated that, the rotation of the implement system 110 may be made in anti-clockwise direction as well which may be dependent on the real time requirements at the worksite 102.

In the illustrated embodiment in the FIG. 6B, the body 122 or the cabin of the machine 100 is rotated from a position K1 to a position K2 by touching and rotating a profile, such as a circle C2. Initially the body 122 may be positioned to be in the position K1 and when the operator desires to bring the position of the body 122 to another position, for example, the position K2, the operator touches and rotates the circle C2 to a required angle in a clockwise direction for rotating the body 122 along the second plane X-Y. It is contemplated that the rotation of the body 122 may be made in anti-clockwise direction as well which may be dependent on the real time requirements at the worksite 102.

In an embodiment, if the operator desires to rotate the implement system 110 along with the rotation of the body 122, the operator may rotate the circles C1 and C2 independently or simultaneously to move/rotate the implement system 110 and the body 122 from their current positions to any desired positions. It may be contemplated that the operator may rotate the implement system 110 first and the body 122 thereafter and vise-versa.

In an embodiment, the interactive display unit 108 in communication with the controller 202 is configured to display a real time angle of rotation of the implement system 110 and the body 122 about the second plane X-Y. The controller 202 in communication with the interactive display unit 108 determines the angle of rotation and communicates the angle of rotation to display on the interactive display unit 108. It may also be contemplated that the angle of rotation of the implement system 110 and the body 122 are simultaneously displayed at a display monitor located at the remote station 130 for providing suitable guiding by the supervisor located at the remote station 130.

### INDUSTRIAL APPLICABILITY

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof

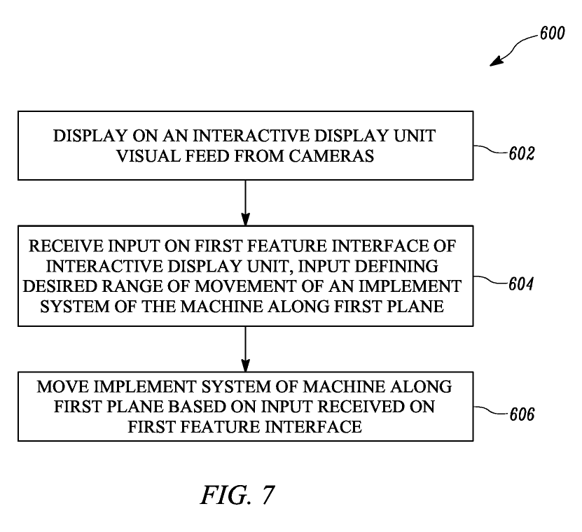

FIG. 7 illustrates a flowchart of a computer-implemented method 600 for operating the first feature interface T1 of the machine 100, according to an embodiment of the present disclosure. When the machine 100 at the worksite 102 is in operating condition, the operator may operate the implement system 110 of the machine 100 for suitable actions. In an embodiment, the interactive display unit 108 disposed at the dashboard of the machine 100 displays the images of the surrounding areas A1 and A2 based on the input request from the operator by selecting desired icons of the camera. The interactive display unit 108 displays the first feature interface T1 and the second feature interface T2 and the image of the area of the worksite 102 at the portion 108b. At step 602, the operator provides a second input at the second feature interface T2 on the interactive display unit 108 for providing the visual feed from any of the plurality of cameras. In the illustrated embodiment as shown in FIG. 3, the operator has requested at the second feature interface T2 for the visual feed from the camera 118. After the request for the visual feed from the operator, the interactive display unit 108 displays the image of the surrounding area at front end of the machine 100 at the portion 108b in the interactive display unit 108. In an embodiment, the operator may request the visual feed from any of the plurality of cameras to display the visual feed at the portion 108b in the interactive display unit 108 for operating the implement system 110 during working. At step 604, the operator may input for defining range of the movement of the implement system 110 along the first plane Y-Z based on the image of the surrounding area displayed at the portion 108b. At step 606, the operator moves the implement system 110 to a desired position for operating the machine 100 based on the input received on the first feature interface T1.

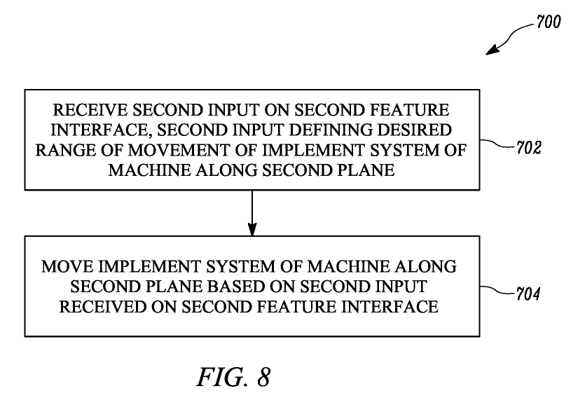

FIG. 8 illustrates a flowchart of a computer-implemented method 700 for operating the second feature interface T2 of the machine 100, according to an embodiment of the present disclosure. At step 702, an input from the operator on the second feature interface T2 is requested to display desired range of movement of the implement system 110 along the second plane X-Y. After the input request, the operator rotates the implement system 110 based on the range of movement of the implement system 110, at step 704. Further, the operator may rotate the body 122 of the machine 100 along the second plane X-Y.

In an embodiment, the visual feed generated by the plurality of cameras 114, 115, 116, 118, 124, 126 and 128 on the interactive display unit 108 may be provided to the operator in real time, therefore the operator remains aware about the worksite 102, the articles at the worksite 102 and the position of the machine 100. Since the interactive display unit 108 may be a part of a mobile communication device such as a laptop, or a handheld mobile, the operator may remain away from the worksite 102, while being aware about the worksite 102, articles on the worksite 102 and the position of the machine 100, based on the real time visual feed generated by the plurality of cameras 114, 115, 116, 118, 124, 126 and 128 on the interactive display unit 108.

In an embodiment, the interactive display unit 108 is provided with the first feature interface T1 and the second feature interface T2. Each of the first feature interface T1 and the second feature interface T2 enable the operator to accurately and conveniently operate the machine 100 and the work tool 106. The GUI of the first feature interface T1 and the second feature interface T2, also simultaneously convey to the operator the relative position of the work tool 106 and the boom 104, thus keeping the operator constantly aware of the position thereof.

The system 200 including the interactive display unit 108 is a tablet excavator control device. The transparent overlay 108a including a profile image of the excavator range of motion for the first plane Y-Z and a representation of the angular position of the implement system 110 relative to the tracks enables easy operation or control of the excavator machine. The interactive display unit 108 including operator-selected onboard or off-board camera feeds as a background for the overlay provides selection of any cameras for monitoring views proximal to the machine 100 and the worksite 102.

The system 200 being a touch based device, during the usage of the system 200, the operator uses touch control actions to control the cameras, control the excavator machine and the implement system 110. Further, the system 200 may also be useful to draw and modify dig cycle profiles before execution is performed.

Further, the interactive display unit 108 may also be configured to determine an angle of the operator's finger with respect the screen of the interactive display unit 108. This may provide an advantage to operate the implement system 110 by the operator using one finger for position and tilt control of the bucket.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for operating a machine, the system comprising:
an input unit having a plurality of cameras associated with the machine and a worksite, the input unit adapted to generate a visual feed associated with the machine and the work site;
a controller, in communication with the input unit, to receive the visual feed generated by the plurality of cameras; and
an interactive display unit, in communication with the controller,
wherein the controller is adapted to,
display the visual feed generated by one or more of the plurality of cameras on the interactive display unit;
display a first feature interface on the interactive display unit to allow a first input from an operator for movement of an implement system of the machine along a first plane; and,
display a second feature interface on the interactive display unit to allow a second input from the operator for movement of the implement system of the machine along a second plane.

2. The system of claim 1, wherein the controller is further configured to receive an input for selection of one or more of the plurality of cameras for displaying the visual feed.

3. The system of claim 1, wherein the input unit includes:
one or more on-board cameras provided on the machine; and
one or more off-board cameras provided on the worksite.

4. The system of claim 1, wherein the first feature interface includes a first Graphical User Interface (GUI) of a range of motion of the implement system along the first plane.

5. The system of claim 4, wherein the first feature interface includes a first Graphical User Interface (GUI) indicating a range of motion of a work tool along the first plane.

6. The system of claim 5, wherein the first feature interface is adapted to receive a first input for moving the implement system along the first plane, and a work tool movement input for moving the work tool of the implement system with respect to the implement system along the first plane.

7. The system of claim 6, wherein the second feature interface includes a second Graphical User Interface (GUI) indicating the implement system range of motion along the second plane.

8. The system of claim 7, wherein the machine is an excavator and the work tool is a bucket.

9. The system of claim 1, wherein the controller and the interactive display unit are configured to integrally form a part of a mobile computing device.

10. The system of claim 9, wherein the mobile computing device is one of a laptop, a Personal Digital Assistant (PDA), a tablet device, and a smartphone.

11. The system of claim 1, wherein the first plane is a vertical plane and the second plane is perpendicular to the first plane.

12. A computer-implemented method of operating a machine, the method comprising;
displaying, on an interactive display unit, a visual feed from one or more of a plurality of cameras;
receiving an input on a first feature interface of the interactive display unit, the input defining a desired range of movement of an implement system of the machine along a first plane; and
moving the implement system of the machine along the first plane according to the input received on the first feature interface.

13. The computer-implemented method of claim 12 further comprising:
receiving a second input on a second feature interface, the second input defining a desired range of movement of the implement system of the machine along a second plane; and
moving the implement system of the machine along the second plane according to the second input received on the second feature interface.

14. The computer-implemented method of claim 13 further comprising:
selecting one of more of the plurality of cameras to provide a visual feed to a display unit of the interactive display unit.

15. The method of claim 12 wherein a first input on the first feature interface is a draw and dig work cycle of the machine.
